(19) United States
(12) Patent Application Publication
(10) Pub. No.: US 2019/0066007 A1
(43) Pub. Date: Feb. 28, 2019

(54) MEASURING LABOR MARKET FRICTION USING SOCIAL NETWORKING MEMBER INFORMATION AS A PROXY FOR NATIONWIDE LABOR STATISTICS

(71) Applicant: Microsoft Technology Licensing, LLC, Redmond, WA (US)

(72) Inventors: Rahul Aggarwal, Milpitas, CA (US); Francis Edmond MacCrory, III, Philadelphia, PA (US); Noel Dominic Sequeira, New York, NY (US); Parul Batra, Mountain View, CA (US); George Westerman, Somerville, MA (US)

(21) Appl. No.: 15/692,131

(22) Filed: Aug. 31, 2017

(51) Int. Cl. G06Q 10/06; G06Q 10/04; G06Q 10/10; G06Q 50/00; H04L 29/08; G06F 3/0481

(52) U.S. Cl. CPC G06Q 10/063; G06Q 10/04; G06F 3/0481; G06Q 50/01; H04L 67/306; G06Q 10/105

(57) ABSTRACT

Example methods and systems are directed to measuring labor market friction using social networking member information as a proxy for nationwide labor statistics. As nationwide labor statistics are often generic, the social networking member information can serve as a way to more granularly identify where labor market frictions are occurring across communities and/or industries. A user selects one or more labor pool criterion for selecting job postings of a social networking service to be included in the desired labor market. The labor pool criterion are also used to select potential members of the social networking service to be included in the desired labor market. Various comparisons are then made to match the member profiles of the potential members with the selected job postings to determine vacancy rates and potential job seekers. These values are then used to highlight geographic regions where there may be labor market friction.

### TECHNICAL FIELD

The subject matter disclosed herein generally relates to measuring labor market friction and, in particular, using the member profile information from one or more members of a social networking service as a proxy for nationwide labor statistics in determining the labor market friction.

### BACKGROUND

Frictional unemployment is the unemployment that results from time spent between jobs when a worker is searching for, or transitioning from one job to another. Frictional unemployment can occur because jobs and workers are typically heterogeneous, and a mismatch can result between the characteristics of supply and demand. Such a mismatch can be related to skills, payment, worktime, location, attitude, taste, and a multitude of other factors. New entrants (such as graduating students) and re-entrants (such as former homemakers) can also suffer frictional unemployment.

The frictions in the labor market are sometimes illustrated graphically with a Beveridge curve, a downward-sloping, convex curve that shows a fixed relationship between the unemployment rate on one axis and the vacancy rate on the other. Changes in the supply of or demand for labor cause movements along this curve. An increase in labor market frictions will shift the curve outwards, and vice versa. A longer term form of frictional unemployment is structural unemployment which is very similar.

However, frictional unemployment is often determined at a national level using nationally available metrics. These metrics often do not include granular (e.g., local) information to make an informed decision about why the frictional unemployment exists. Thus, policymakers are often challenged in attempting to formulate policy or informed decisions about how to address this frictional unemployment.

### BRIEF DESCRIPTION OF THE DRAWINGS

Some embodiments are illustrated by way of example and not limitation in the figures of the accompanying drawings.

FIG. 1 is a block diagram illustrating a networked system, according to some example embodiments, including a social networking server.

FIG. 2 illustrates the social networking server of FIG. 1, according to an example embodiment.

FIGS. 3A-3B illustrate a method, in accordance with an example embodiment, for determining frictional unemployment using the social networking information from the social networking server of FIG. 1.

FIGS. 4A-4D illustrate Beveridge curves for specific industries using the social networking information, according to example embodiments.

FIG. 5 illustrates a graph of unemployment rates determined by the social networking server of FIG. 1 using social networking information, according to an example embodiment.

FIG. 6 illustrates a graph of changes in employment rates for various industries determined by the social networking server of FIG. 1, according to an example embodiment.

FIG. 7A-7B illustrate heatmaps illustrating jobseeking intensity by members of a social networking service, according to example embodiments.

FIG. 8 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods and systems are directed to measuring labor market friction using social networking member information as a proxy for nationwide labor statistics. As nationwide labor statistics are often generic, the social networking member information can serve as a way to more granularly identify where labor market frictions are occurring across communities and/or industries.

In one embodiment, this disclosure describes a system comprising a machine-readable medium storing computer-executable instructions, and at least one hardware processor communicatively coupled to the machine-readable medium that, when the computer-executable instructions are executed, configures the system to receive a selection of a plurality of labor pool criterion for establishing a labor pool criteria and determine a first plurality of job postings that satisfy the labor pool criteria, the first plurality of job postings being determined from a second plurality of job postings available from a social networking service, wherein at least one job posting of the first plurality of job postings identifies a job to be performed. The system may be further configured to determine a first plurality of member profiles that match with one or more of the first plurality of job postings, the first plurality of member profiles being selected from a second plurality of member profiles of the social networking service, calculate a plurality of vacancy rates for a plurality of geographic regions based on the determined first plurality of job postings, each vacancy rate corresponding to a geographic region, and calculate a plurality of jobseeker percentages for the plurality of geographic regions, each jobseeker percentage corresponding to a geographic region. The system may also be configured to determine a plurality of ratios for the plurality of geographic regions, each ratio begin determined based on a vacancy rate and jobseeker percentage for a corresponding geographic region, generate a first image that illustrates the plurality of ratios, wherein the first image comprises a two-dimensional graph, the graph having a horizontal axis corresponding to the plurality of jobseeker percentages and a vertical axis corresponding to the plurality of vacancy rates, and communicate the first image for display by a client device in communication with the system.

In another embodiment of the disclosed system, the plurality of labor pool criterion include at least one of an industry, an employment salary, a geographic region, and an organization type.

In a further embodiment of the disclosed system, a member profile selected from the first plurality of member profiles is determined by comparing the member profile selected from the second plurality of member profiles with each job posting of the first plurality of job postings to obtain a plurality of match scores, each match score corresponding to a comparison of the member profile with a corresponding job posting, and determining whether any of the match scores of the plurality of match scores exceeds a predetermined match score threshold.

In yet another embodiment of the disclosed system, the system is further configured to select the member profile as matching with a corresponding job posting in response to a determination that the corresponding match score exceeds the predetermined match score threshold.

In yet a further embodiment of the disclosed system, the system is further configured to obtain a plurality of match scores for each job posting of the first plurality of job postings by determining a match score for each member profile of the first plurality of member profiles, compare each of the match scores with each plurality of match scores to determine a highest match score in each of the plurality of match scores, and assign each job posting of the first plurality of job postings with the corresponding highest match score determined from the corresponding plurality of match scores associated with each job posting.

In another embodiment of the disclosed system, calculating the vacancy rates for the plurality of geographic regions is further based on the highest match scores assigned to the first plurality of job postings.

In a further embodiment of the disclosed system, the system is further configured to generate a second image that illustrates the plurality of ratios, wherein the second image further illustrates the plurality of geographic regions with a corresponding color shade, each geographic region being associated a color shade corresponding to the ratio associated with the geographic region.

Each embodiment of the system disclosed above may be further combined with any other embodiment of the system disclosed herein.

This disclosure also describes a method that includes receiving a selection of a plurality of labor pool criterion for establishing a labor pool criteria, determining a first plurality of job postings that satisfy the labor pool criteria, the first plurality of job postings being determined from a second plurality of job postings available from a social networking service, wherein at least one job posting of the first plurality of job postings identifies a job to be performed, and determining a first plurality of member profiles that match with one or more of the first plurality of job postings, the first plurality of member profiles being selected from a second plurality of member profiles of the social networking service. The method also includes calculating a plurality of vacancy rates for a plurality of geographic regions based on the determined first plurality of job postings, each vacancy rate corresponding to a geographic region, calculating a plurality of jobseeker percentages for the plurality of geographic regions, each jobseeker percentage corresponding to a geographic region, and determining a plurality of ratios for the plurality of geographic regions, each ratio begin determined based on a vacancy rate and jobseeker percentage for a corresponding geographic region. The method further includes generating a first image that illustrates the plurality of ratios, wherein the first image comprises a two-dimensional graph, the graph having a horizontal axis corresponding to the plurality of jobseeker percentages and a vertical axis corresponding to the plurality of vacancy rates, and communicating the first image for display by a client device.

In another embodiment of the disclosed method, the plurality of labor pool criterion include at least one of an industry, an employment salary, a geographic region, and an organization type.

In a further embodiment of the disclosed method, a member profile selected from the first plurality of member profiles is determined by comparing the member profile selected from the second plurality of member profiles with each job posting of the first plurality of job postings to obtain a plurality of match scores, each match score corresponding to a comparison of the member profile with a corresponding job posting, and determining whether any of the match scores of the plurality of match scores exceeds a predetermined match score threshold.

In yet another embodiment of the disclosed method, the method includes selecting the member profile as matching with a corresponding job posting in response to a determination that the corresponding match score exceeds the predetermined match score threshold.

In yet a further embodiment of the disclosed method, the method includes obtaining a plurality of match scores for each job posting of the first plurality of job postings by determining a match score for each member profile of the first plurality of member profiles, comparing each of the match scores with each plurality of match scores to determine a highest match score in each of the plurality of match scores, and assigning each job posting of the first plurality of job postings with the corresponding highest match score determined from the corresponding plurality of match scores associated with each job posting.

In another embodiment of the disclosed method, calculating the vacancy rates for the plurality of geographic regions is further based on the highest match scores assigned to the first plurality of job postings.

In a further embodiment of the disclosed method, the method includes generating a second image that illustrates the plurality of ratios, wherein the second image further illustrates the plurality of geographic regions with a corresponding color shade, each geographic region being associated a color shade corresponding to the ratio associated with the geographic region.

Each embodiment of the method disclosed above may be further combined with any other embodiment of the method disclosed herein.

This disclosure further provides for a non-transitory, machine-readable medium having computer-executable instructions stored thereon that, when executed by at least one hardware processor, causes a computer to perform a plurality of operations comprising receiving a selection of a plurality of labor pool criterion for establishing a labor pool criteria, determining a first plurality of job postings that satisfy the labor pool criteria, the first plurality of job postings being determined from a second plurality of job postings available from a social networking service, wherein at least one job posting of the first plurality of job postings identifies a job to be performed, and determining a first plurality of member profiles that match with one or more of the first plurality of job postings, the first plurality of member profiles being selected from a second plurality of member profiles of the social networking service. The plurality of operations also include calculating a plurality of vacancy rates for a plurality of geographic regions based on the determined first plurality of job postings, each vacancy rate corresponding to a geographic region, calculating a plurality of jobseeker percentages for the plurality of geographic regions, each jobseeker percentage corresponding to a geographic region, and determining a plurality of ratios for the plurality of geographic regions, each ratio begin determined based on a vacancy rate and jobseeker percentage for a corresponding geographic region. The plurality of operations further include generating a first image that illustrates the plurality of ratios, wherein the first image comprises a two-dimensional graph, the graph having a horizontal axis corresponding to the plurality of jobseeker percentages and a vertical axis corresponding to the plurality of vacancy rates, and communicating the first image for display by a client device.

In another embodiment of the non-transitory, machine-readable medium, the plurality of labor pool criterion include at least one of an industry, an employment salary, a geographic region, and an organization type.

In a further embodiment of the non-transitory, machine-readable medium, a member profile selected from the first plurality of member profiles is determined by comparing the member profile selected from the second plurality of member profiles with each job posting of the first plurality of job postings to obtain a plurality of match scores, each match score corresponding to a comparison of the member profile with a corresponding job posting, and determining whether any of the match scores of the plurality of match scores exceeds a predetermined match score threshold.

In yet another embodiment of the non-transitory, machine-readable medium, the plurality of operations further comprises selecting the member profile as matching with a corresponding job posting in response to a determination that the corresponding match score exceeds the predetermined match score threshold.

In yet a further embodiment of the non-transitory, machine-readable medium, the plurality of operations further comprises obtaining a plurality of match scores for each job posting of the first plurality of job postings by determining a match score for each member profile of the first plurality of member profiles, comparing each of the match scores with each plurality of match scores to determine a highest match score in each of the plurality of match scores, and assigning each job posting of the first plurality of job postings with the corresponding highest match score determined from the corresponding plurality of match scores associated with each job posting.

In another embodiment of the non-transitory, machine-readable, calculating the vacancy rates for the plurality of geographic regions is further based on the highest match scores assigned to the first plurality of job postings.

Each embodiment of the non-transitory, machine-readable medium disclosed above may be further combined with any other embodiment of the non-transitory, machine-readable medium disclosed herein.

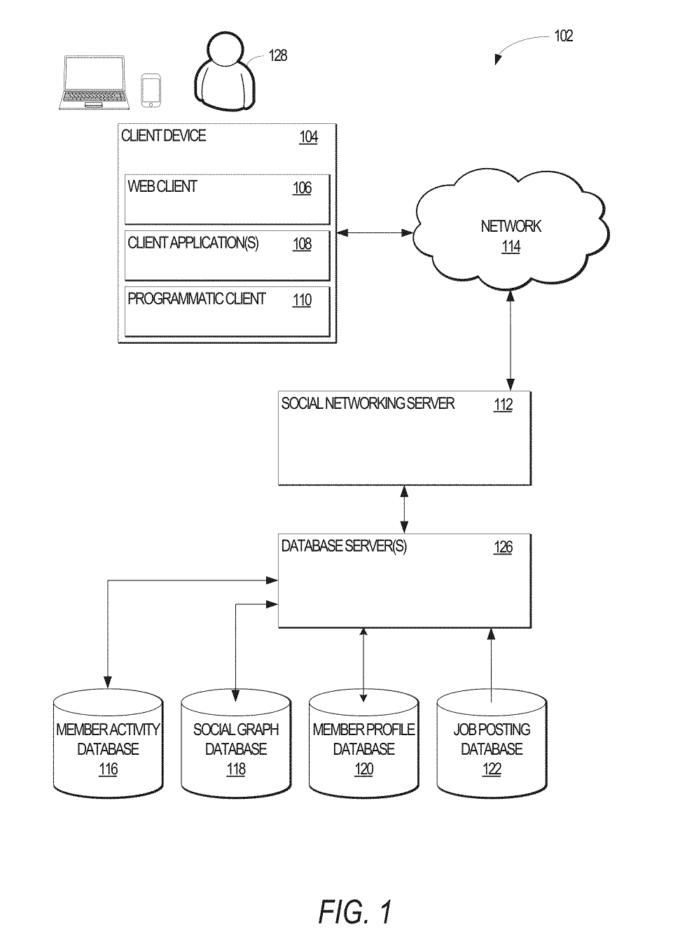

With reference to FIG. 1, an example embodiment of a high-level client-server-based network architecture 102 is shown. A social networking server 112 provides server-side functionality via a network 114 (e.g., the Internet or wide area network (WAN)) to one or more client devices 104. FIG. 1 illustrates, for example, a web client 106 (e.g., a browser, such as the Internet Explorer® browser developed by Microsoft® Corporation of Redmond, Wash. State), client application(s) 108, and a programmatic client 110 executing on client device 104. The social networking server 112 is further communicatively coupled with one or more database servers 122 that provide access to one or more databases 116-122.

The client device 104 may comprise, but is not limited to, a mobile phone, desktop computer, laptop, portable digital assistant (PDA), smart phone, tablet, ultra book, netbook, laptop, multi-processor system, microprocessor-based or programmable consumer electronic, or any other communication device that a user 128 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth. The client device 104 may be a device of a user 128 that is used to perform one or more searches for user profiles accessible to, or maintained by, the social networking server 112.

In one embodiment, the social networking server 112 is a network-based appliance that responds to requests from the client device 104 to provide one or more services. A user 128 may use the client device 104, and the one or more users 128 may be a person, a machine, or other means of interacting with the client device 104. In various embodiments, the user 128 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 104 may include one or more applications (also referred to as “apps”) such as, but not limited to, a web browser, messaging application, electronic mail (email) application, a social networking access client, and the like. In some embodiments, if the social networking access client is included in the client device 104, then this application is configured to locally provide the user interface and at least some of the functionalities with the application configured to communicate with the social networking server 112, on an as needed basis, for data and/or processing capabilities not locally available (e.g., access to a member profile, to authenticate a user 128, to identify or locate other connected members, etc.). Conversely if the social networking access client is not included in the client device 104, the client device 104 may use its web browser to access the initialization and/or search functionalities of the social networking server 112.

One or more users 128 may be a person, a machine, or other means of interacting with the client device 104. In example embodiments, the user 128 is not part of the network architecture 102, but may interact with the network architecture 102 via the client device 104 or other means. For instance, the user 128 provides input (e.g., touch screen input or alphanumeric input) to the client device 104 and the input is communicated to the client-server-based network architecture 102 via the network 114. In this instance, the social networking server 112, in response to receiving the input from the user 128, communicates information to the client device 104 via the network 114 to be presented to the user 128. In this way, the user 128 can interact with the social networking server 112 using the client device 104.

Further, while the client-server-based network architecture 102 shown in FIG. 1 employs a client-server architecture, the present subject matter is of course not limited to such an architecture, and could equally well find application in a distributed, or peer-to-peer, architecture system, for example.

In addition to the client device 104, the social networking server 112 communicates with other one or more database server(s) 124 and/or database(s) 116-122. In one embodiment, the social networking server 112 is communicatively coupled to a member activity database 116, a social graph database 118, a member profile database 120, and a job posting database 122. The databases 116-122 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some embodiments, when a person initially registers to become a member of the social networking service provided by the social networking server 112, the person is prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the member profile database 120. Similarly, when a representative of an organization initially registers the organization with the social networking service provided by the social networking server 112, the representative may be prompted to provide certain information about the organization. This information may be stored, for example, in the member profile database 120. With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

A member profile may also include information identifying one or more skills that a corresponding has identified as possessing. For example, the member may identify that he or she possesses computer programming skills (e.g., “Computer Programming,” “Debugging,” “C++,” etc.), writing skills (e.g., “Writing,” “Drafting,” etc.), legal skills (e.g., “Contract drafting,” “Document review,” “Litigation,” etc.) and other such skills and/or combination of skills. In one embodiment, the member provides information to the social network service via a graphical user interface (e.g., a webpage), which then updates the member's member profile with the provided skills. Additionally, and/or alternatively, the social networking service may provide a list and/or selectable skills that the member may identify as possessing. In this manner, a member profile includes skills that the member has identified as possessing.

The member profile data may further include a description or summary of the type of tasks and/or jobs that the member has performed during his or her career and/or associate them with one or more organizations. For example, the member may provide a description of the type of work that he or she has performed while employed at a given employer. Similarly, the member may provide a description of the type of courses and/or activities that he or she engaged in while attending a given educational institution (e.g., a university). Regardless of the organization type (e.g., educational, government, private company, non-profit, etc.), the social networking service provides a graphical user interface (e.g., a webpage) that allows the member to provide information about his or her duties and/or activities while attending or employed at a given organization. Thus, the member profile may be leveraged as a substitute resume for the corresponding member.

The member profile data may also include geographic information about the member. The geographic information may include, but is not limited to, the current and/or approximate location of the member, the approximate location of the member where he or she last accessed the social networking server 112, the approximate location of one or more employers of the member, such as a current employer or past employer(s), and other such geographic information or combination of information. The geographic information may be generic as to a region (e.g., Northeast), may identify a particular city, state, province, country, or may be particular as to a specific latitude and/or longitude. In this manner, the member profile includes geographic information about the corresponding member.

Members of the social networking service may establish connections with one or more members and/or organizations of the social networking service. The connections may be defined as a social graph, where the member and/or organization is represented by a vertex in the social graph and the edges identify connections between vertices. In this regard, the edges may be bilateral (e.g., two members and/or organizations have agreed to form a connection), unilateral (e.g., one member has agreed to form a connection with another member), or combinations thereof. In this manner, members are said to be first-degree connections where a single edge connects the vertices representing the members; otherwise, members are said to be “nth”-degree connections where “n” is defined as the number of edges separating two vertices. As an example, two members are said to be “2nd-degree” connections where each member shares a connection in common with the other member, but the members are not directly connected to one another. In one embodiment, the social graph maintained by the social networking server 112 is stored in the social graph database 118.

Although the foregoing discussion refers to “social graph” in the singular, one of ordinary skill in the art will recognize that the social graph database 118 may be configured to store multiple social graphs. For example, and without limitation, the social networking server 112 may maintain multiple social graphs, where each social graph corresponds to various geographic regions, industries, members, or combinations thereof.

As members interact with the social networking service provided by the social networking server 112, the social networking server 112 is configured to monitor these interactions. Examples of interactions include, but are not limited to, commenting on content posted by other members, viewing member profiles, editing or viewing a member's own profile, sharing content outside of the social networking service (e.g., an article provided by an entity other than the social networking server 112), updating a current status, posting content for other members to view and/or comment on, and other such interactions. In one embodiment, these interactions are stored in a member activity database 116, which associates interactions made by a member with his or her member profile stored in the member profile database 120.

The social networking service may further include a job posting database 122 that includes data related to one or more job postings provided by and/or accessible from the social networking service. In one embodiment, a job posting includes various job fields describing the job associated with the job posting. One or more of these job fields may be publicly viewable job fields and one or more of these job fields may be private job fields that are not viewable by members of the social networking service. Publicly viewable job fields include, but are not limited to, a job title field that includes information about the job title, a job description field that includes information describing the job, an employer field that includes information about the employer for the job, a job qualification field that includes information about the qualifications a job candidate should possess when applying to the job.

Private job fields include, but are not limited to, a job posting identifier field that includes a unique identifier that identifies the job posting, a candidate skill field that includes information about the skills that a job candidate should possess, a job poster field that includes information about the entity that created and/or posted the job posting, and other such fields and/or combination of fields. In the context of the job skill field, the job skill field may be populated with o one or more standardized names of skills selected from one or more sets of standardized skills that the social networking service maintains in order to more readily identify potential candidates from among members of the social networking service.

Furthermore, one or more of the job fields associated with the job posting may be indexed and/or searchable by one or more search engines. For example, the publicly viewable job fields may be indexed and/or searchable by the one or more search engines. Thus, in response to a search query submitted to a given search engine, the user of the search engine, who may or may not be a member of the social networking service, may be presented with one or more of the job postings stored in the job posting database 122.

In one embodiment, the social networking server 112 communicates with the various databases 116-122 through one or more database server(s) 124. In this regard, the database server(s) 124 provide one or more interfaces and/or services for providing content to, modifying content in, removing content from, or otherwise interacting with, the databases 116-122. For example, and without limitation, such interfaces and/or services may include one or more Application Programming Interfaces (APIs), one or more services provided via a Service-Oriented Architecture (SOA), one or more services provided via a REST-Oriented Architecture (ROA), or combinations thereof. In an alternative embodiment, the social networking server 112 communicates with the databases 116-122 and includes a database client, engine, and/or module, for providing data to, modifying data stored within, and/or retrieving data from, the one or more databases 116-122.

While the database server(s) 124 is illustrated as a single block, one of ordinary skill in the art will recognize that the database server(s) 124 may include one or more such servers. For example, the database server(s) 124 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-124, or combinations thereof. Accordingly, and in one embodiment, the database server(s) 124 implemented by the social networking service are further configured to communicate with the social networking server 112.

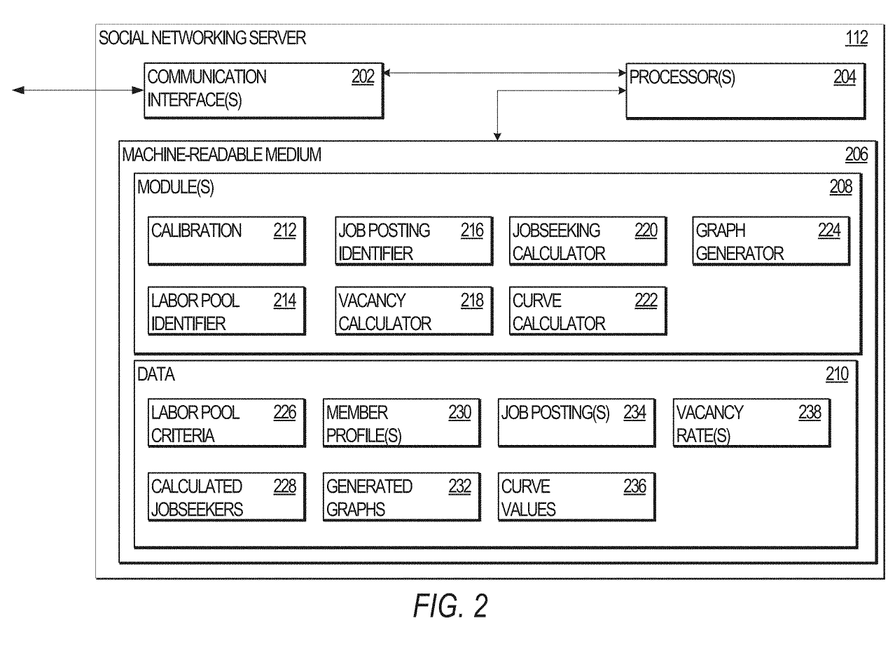

FIG. 2 illustrates the social networking server 112 of FIG. 1, in accordance with an example embodiment. In one embodiment, the social networking server 112 includes one or more processor(s) 204, one or more communication interface(s) 202, and a machine-readable medium 206 that stores computer-executable instructions for one or more applications 208 and data 210 used to support one or more functionalities of the applications 208.

The various functional components of the social networking server 112 may reside on a single device or may be distributed across several computers in various arrangements. The various components of the social networking server 112 may, furthermore, access one or more databases (e.g., databases 116-122 or any of data 210), and each of the various components of the social networking server 112 may be in communication with one another. Further, while the components of FIG. 2 are discussed in the singular sense, it will be appreciated that in other embodiments multiple instances of the components may be employed.

The one or more processors 204 may be any type of commercially available processor, such as processors available from the Intel Corporation, Advanced Micro Devices, Texas Instruments, or other such processors. Further still, the one or more processors 204 may include one or more special-purpose processors, such as a Field-Programmable Gate Array (FPGA) or an Application Specific Integrated Circuit (ASIC). The one or more processors 204 may also include programmable logic or circuitry that is temporarily configured by software to perform certain operations. Thus, once configured by such software, the one or more processors 204 become specific machines (or specific components of a machine) uniquely tailored to perform the configured functions and are no longer general-purpose processors.

The one or more communication interfaces 202 are configured to facilitate communications between the client device 104, the social networking server 112, and one or more of the database server(s) 124 and/or databases 116-122. The one or more communication interfaces 202 may include one or more wired interfaces (e.g., an Ethernet interface, Universal Serial Bus (USB) interface, a Thunderbolt® interface, etc.), one or more wireless interfaces (e.g., an IEEE 802.11b/g/n interface, a Bluetooth® interface, an IEEE 802.16 interface, etc.), or combinations of such wired and wireless interfaces.

The machine-readable medium 206 includes various applications 208 and data 210 for implementing the client device 104. The machine-readable medium 206 includes one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the applications 208 and the data 210. Accordingly, the machine-readable medium 206 may be implemented as a single storage apparatus or device, or, alternatively and/or additionally, as “cloud-based” storage systems or storage networks that include multiple storage apparatus or devices. As shown in FIG. 2, the machine-readable medium 206 excludes signals per se.

In one embodiment, the applications 208 are written in a computer-programming and/or scripting language. Examples of such languages include, but are not limited to, C, C++, C#, Java, JavaScript, Perl, Python, or any other computer programming and/or scripting language now known or later developed.

With reference to FIG. 2, the modules 208 of the social networking server 112 are configured to determine labor market friction for a geographic area and/or industry given an identified labor market and potential job opportunities. To perform these and other operations in determining the labor market friction, the modules 208 include, but are not limited to, a calibration module 212, a labor pool identifier 214, and a job posting identifier 216. The modules 208 also include a vacancy calculator 218, a jobseeking calculator 220, a curve calculator 222, and a graph generator 224. While the social networking server 112 may include alternative and/or additional modules or applications (e.g., a networking application, a printing application, an operating system, a web server, various background and/or programmatic services, etc.), such alternative and/or additional applications are not germane to this disclosure and the discussion of such is hereby omitted for brevity and readability.

The data 210 referenced and used by the applications 208 include various types of data in support of determining the labor market friction for a particular geography and/or industry. In this regard, the data 210 includes, but is not limited to, labor market criteria 226, one or more calculated jobseekers 228, one or more member profile(s) 230, various generated graphs 232, one or more posting(s) 234, curve values 236, and one or more vacancy rate(s) 238.

The labor pool criteria 226 includes one or more criterion that indicate the type of members and/or job postings that are to be included in a labor pool used to determine the labor market friction. The criterion may be determined by an operator or administrator of the social networking server 112. Depending on whether members of the social networking service have permissions to modify the labor pool criteria 226, one or more members of the social networking service may also define and/or establish the one or more criterion used to define the labor pool. Furthermore, defining the criterion for the labor pool criteria 226 may include defining the particular criterion used in the labor pool criteria 226 and/or the values of each of the criterion of the labor pool criteria 226. A graphical user interface, such as those implemented by an operating system or software application, may be employed to modify the labor pool criteria 226. Examples of criterion that may define the labor pool include, but are not limited to, a geographic region and/or area (e.g., a country, state, city, etc.), an industry, a salary range or amount, an organization type, an organization title, educational institution attended, educational degrees earned, and other such criterion or combinations thereof. Each of the foregoing criterion may be further associated with one or more values which, as discussed below, are then matched (or approximately matched) with attributes from the one or more member profile(s) 230 and/or the job posting(s) 234.

Using a graphical user interface, a member may select which of the values to use for each of the criterion of the labor pool criteria 226. Thus, the member may select one or more values for a geographic region (e.g., “Illinois” and “West Virginia), one or more industries (e.g., “Technology,” “Oil & Gas,” “Renewables,”), one or more organization types (e.g., “Government,” “Private Sector,” “Non-Profit,” “For-Profit,” etc.), and other such values or combination of values. By selecting the values to use in the labor pool criteria 226, the member effectively defines the economy of interest to use in determining the labor market friction. The labor pool criteria 226 may be represented as a selection criteria vector 6.

As the member population of the social network is used as a proxy for nationwide statistics, the social networking server 112 is configured to perform an initial calibration to account for the differences between the workforce population of the social network and the workforce population of a country. In one embodiment, the calibration module 212 is configured to perform one or more operations that establish the parameter values used in calculating the labor market friction for a given geography and/or industry. One of the challenges in using a social network's membership is that the membership may not include all persons in a potential workforce. This disparity means that sample statistics that can be calculated using the social network's membership may vary from population statistics that the embodiments disclosed herein are attempting to estimate. In one embodiment, the calibration module 212 applies one or more regression models to selected observations for one or more datasets obtained from the social networking server 212. For example, the datasets may include a selected population type (e.g., executives) and a geographic area (e.g., a particular state, county, or other region) for a predetermined time period (e.g., six months, one year, etc.). Different transformations may be applied to different statistics obtained from these datasets, e.g., logarithmic transformations for ratios, logit transformations for fractions, and other such transformations. The obtained observations may then be weighted based on the precision of the benchmark estimates.

In another embodiment, the calibration module 212 determines a member weight value that is carried through to one or more statistics determined by the social networking server 112 in determining the labor market friction for a particular geography. For example, using a set of observables present in a first dataset obtained from publicly available sources (e.g., the Public Use Microdata Sample (PUMS) provided by the U.S. Census Bureau) and a second dataset obtained from the social networking server 112, the calibration module 212 may sum the person-weights in the PUMS and count the occurrences of the same cluster in the second dataset obtained from the social networking service. The calibration module 212 may then assign this value as the member-weight value that is then carried through to other sample statistics.

In yet a further embodiment, the calibration module 212 regresses the log of a “benchmark estimate:social networking service” ratio on a set of dummy variables for two or more dimensions of categories (e.g., supertitle dummies, industry dummies, time period dummies, etc.). These observations may then be weighted according to the precision of the benchmark estimate.

In determining the labor market friction, the social networking server 112 may initially determine a percentage of job openings relative to a selected labor force size. In this regard, the percentage of job openings may be represented as a fraction, where the numerator is representative of the number of job openings (e.g., vacancies) and the denominator represents the particular labor force size.

In determining this first percentage, the social networking service 112 invokes a job posting identifier module 216 that initially identifies one or more job posting(s) 234 that are available via the social networking service. In this context, a job posting is an offer for a position with an organization (e.g., a job) that has not yet been filled.

In one embodiment, the job posting identifier module 216 queries the job posting database 122 to obtain one or more job posting(s) 234. In querying the job posting database 122, the job posting identifier module 216 may query the job posting database 122 to return one or more job posting(s) 234 that satisfy and/or include one or more particular job posting attribute values that match (or approximately match) corresponding criterion values of the labor pool criteria 226. In general, a job posting attribute is an attribute for the job posting, such as geography, position, organization name, salary information, starting date, industry, and other such job posting attributes. Examples of job posting attribute values include, but are not limited to, “Georgia,” “New York City,” “Executive Director,” “Lawyer,” “ACME Co.,” “$13.50/hr,” “$200,000 per annum,” “Oct. 1, 2017,” “Engineering,” “Renewable Energy,” and other such job attribute values or combinations of values. Thus, to identify the one or more job posting(s) 234, the job posting identifier module 216 attempts to find matching job postings by comparing the job posting attribute values of a selected job posting with the corresponding criterion values of the labor pool criteria 226. Where there is a match, or an approximate match, the selected job posting is added to the identified one or more job posting(s) 234.

In addition, a job posting may have one or more qualifications that a job candidate should possess in order to match with the job posting. Examples of qualifications include education, professional experience, skills, certifications, and other such qualifications. As explained below, the labor pool identifier module 214 identifies those member profiles that satisfy one or more of the qualifications of a given job posting.

Accordingly, the labor pool identifier module 214 is configured to identify a potential labor pool for determining market friction for one or more of the job posting attributes (e.g., geography and/or industry). As discussed explained previously, the social networking server 112 leverages the members of the social networking service as a proxy for the nationwide labor pool. In this regard, the labor pool identifier module 214 identifies those member profiles that are potential matches for one or more of the job posting(s) 234. In one embodiment, the labor pool identifier module 214 attempts to identify matches for each of the job posting(s) 224. The matching between the member profiles of the social networking service and the job posting(s) 224 may be an exact match (e.g., the member profile includes a member profile attribute value that matches one or more of the job posting qualification values), a fuzzy or approximate string match (e.g., the member profile attribute value is relevant to a job posting qualification even if the member profile attribute value does not exactly correspond to the job posting qualification value), or a combination thereof. One methodology for matching the member profiles with the job posting(s) 224 is disclosed in U.S. Pat. No. 8,713,000 to Elman et al. (“Elman”), which is incorporated by reference in its entirety. In one embodiment, the labor pool identifier module 214 uses one or more labor pool criteria 226 to determine the extent of the fuzzy/approximate string matching to be performed. For example, the labor pool criteria 226 may include a fuzzy parameter that can be varied between a value of zero and one to indicate the closeness of the approximate string matching. This allows the labor pool identifier module 214 to include fewer or additional member profiles in the labor pool of the potential workforce.

As member profiles are matched with the one or more job posting(s) 234, the labor pool identifier module 214 determines and/or obtains a matching score that indicates how well a given member profile matches with a corresponding job posting. In one embodiment, the match scores are determined as disclosed in Elman. Thus, the member profiles may be assigned match score between zero and one, where zero indicates that the member profile does not match with a corresponding job posting, and a one indicates that the member profile is a best match with the corresponding job posting. The labor pool identifier module 214 then selects those member profiles as having a match score over a predetermined match threshold, which may be defined as part of the labor pool criteria 226. In one embodiment, the predetermined match threshold is defined at 0.7 such that those member profiles having a match score of 0.7 or higher are then selected as member profile(s) 230 to be included as part of the potential labor pool. The labor pool identifier module 214 then determines a relevant labor force size value based on the match scores determined for each of the selected member profile(s) 230. In one embodiment, the relevant labor force size value is a sum of all of the match scores determined for each of the selected member profile(s) 230. In another embodiment, the relevant labor force size value is a sum of each of the highest match score for each of the job postings.

Formally, a matching function may be defined as μ(i, j; θ) that returns the match score according to the matching algorithm disclosed in Elman, where i represents the identified set of job posting(s) 234, j represents the member profiles to match, and θ represents the labor pool criteria 226. In one embodiment, where the match score does not meet or exceed the predetermined match threshold, the match score for the particular pairing of i, j is assigned a zero value. A monotonic transformation may be applied so that a match score equal to the predetermined match threshold returns a zero value and a match score that is perfect returns a one value.

Having determined the potential labor pool, the social networking server 112 then determines a vacancy value that represents the number of job openings, which serves as a proxy for the potential number of vacant employment positions nationwide. Furthermore, the social networking server 112 determines the percentage of job openings relative to the labor force size. In this regard, the vacancy value is the numerator for the percentage of job openings. Accordingly, and in one embodiment, the social networking server 112 includes a vacancy calculator 218 that determines the vacancy value based on the obtained job posting(s) 234 and the calculated jobseekers 228. As discussed above, the job posting(s) 234 may represent available job openings in a particular geographic area or industry, for different positions, or for different salaries/compensation. As each of the job posting(s) 234 are associated with one or more job posting attributes, the job posting(s) 234 may be filtered according to the values for one or more of the job posting attributes. To determine the vacancy value, the vacancy calculator 218 weights each of the job posting(s) 234 with the corresponding match score determined by the labor pool identifier module 214. The weight assigned to a given job posting may be the highest match score determined for the given job posting (e.g., where a job posting had multiple matches, the match with the highest match score is assigned to the job posting). The vacancy calculator 218 then computes a sum of the match scores assigned to each of the job postings to obtain a calculated vacancy value, which is stored as the vacancy rate(s) 238. The vacancy calculator 218 may be instructed and/or configured to compute one or more of these vacancy values, depending on the job posting attributes used to determine the job posting(s) 234 and/or the identified member profile(s) 230.

Having determined the vacancy value and the potential labor pool, the social networking server 112 then determines the percentage of jobseekers relative to the potential labor pool. Accordingly, and in one embodiment, the jobseeking calculator 220 is configured to determine the percentage of jobseekers using the potential labor pool and the relevant labor force size value. In one embodiment, the percentage of jobseekers is determined based on a volatility score associated with each member profile of the potential labor pool multiplied by a weighting factor, where the weighting factor is the highest match score associated with a given member profile of the potential labor pool. In this embodiment, the volatility score and the weighting factor are used as the numerator in determining the percentage of jobseekers. Furthermore, for this embodiment, the denominator is the sum of one or more weighting factors and, in particular, all the highest match scores for each member profile of the potential labor pool. With this embodiment, the percentage of jobseekers may be represented by the following equation:

$$JS = \frac{{\sum }_{i} [ {Λ}_{i} ( {t}_{i} ; {title}_{i} , {industry}_{i} ) ] \times [ {ω}_{i} ]}{{\sum }_{i} [ {ω}_{i} ]} , \qquad ( eq . 1 )$$

JS is the percentage of members who are actively seeking employment (e.g., “jobseekers”);

i is the number of members in the potential labor pool;

t is a member of the identified labor pool;

title is the title of the member i position at his or her place of employment;

industry is the industry in which the member i is employed;

Λ is a function that returns a value indicating the likelihood that the member t, having title and industry, is searching for alternative employment; and

ω is the highest match score for member i for a job posting selected from the job posting(s) 234.

In one embodiment, ω is determined as a function of the number of matches that a member profile (i) has with the identified job posting(s) 234 (j) according to the labor pool criteria 226 (θ). The ω function may be expressed as:

$$ω ( i , θ ) = {max}_{j} ( μ ( i , j ; θ ) ) \qquad ( eq . 2 )$$

In one embodiment, the Λ function may be implemented as a “job-seeker score” as disclosed in U.S. patent application Ser. No. 13/682,033, titled “TECHNIQUES FOR QUANTIFYING THE JOB-SEEKING PROPENSITY OF MEMBERS OF A SOCIAL NETWORK SERVICE,” and filed Nov. 20, 2012, the disclosure of which is hereby incorporated herein in its entirety.

In determining the jobseeker percentages, the jobseeking calculator 220 may determine multiple jobseeker percentages depending on the labor pool criteria 226, or other selection criteria, used to determine the jobseeker percentages. For example, given multiple geographic regions, such as states of the United States, the jobseeking calculator 220 may determine a jobseeker percentage for each state. At another level of granularity, the geographic regions may be particular towns and/or cities, in which case, the jobseeking calculator 220 determines a jobseeker percentage for each town and/or city. In yet another example, the jobseeking calculator 220 may determine a jobseeker percentage given a two-value pair, such as “industry” and “geographic region.” In this regard, the jobseeking calculator 220 may determine one or more jobseeker percentages given a particular industry, such as “Computer Engineering” and one or more states, towns, or cities. Similarly, the jobseeking calculator 220 may determine one or more jobseeker percentages given multiple industries, such as “Computer Engineering,” “Application Development,” and “Software Testing,” and a specific geographic region, such as “California,” “Cupertino,” or “Mountain View.” In this manner, the jobseeking calculator 220 is configured to determine different jobseeker percentages according to equation one depending on a given selection criteria, such as the labor pool criteria 226.

The curve calculator 222 is configured to determine one or more Beveridge curves for a particular geographic region and/or industry given the percentage of job openings relative to the labor force size (e.g., a “vacancy rate”) and the percentage of jobseekers relative to the potential labor pool (e.g., a “jobseeker rate”). The curve calculator 222 may determine one or more values that correlate to selected geographic regions, selected industries, or a combination thereof. In one embodiment, the curve calculator 222 determines the one or more Beveridge curves using each percentage of the vacancy rates plotted against the jobseeker rates. The jobseeker rates may be used for values along an X-axis whereas the vacancy rates may be plotted along the Y-Axis. The values determined by the curve calculator 222 for each of the Beveridge curves may be stored as the curve values 236 and, as discussed below, may be retrieved by the graph generator 224 is generate various types of graphs.

The graph generator 224 is configured to generate one or more Beveridge curves, bar graphs, two-dimensional heatmap images (e.g., a representation of data in the form of a map or diagram in which data values are represented as colors), and other such images or combination of images. The graph generator 224 may be implemented using any suitable graphing library, extension, or application, such as gnuplot, which is executable on a wide variety of operating systems, or JFreeChart, which is a chart library for the Java programming language. With regard to the Beveridge curves, the graph generator 224 may retrieve the curve values 236 and generate a two-dimensional curve image of the curve values 236 plotted along their corresponding X- and Y-axes. With regard to the bar graphs, the graph generator 224 may generate various bar graphs for industries and/or geographies, depending on the selection criteria used in determining the curve values 236. Finally, as to the heatmap images, the graph generator 224 may generate one or more two-dimensional images given one or more geographic regions represented as two-dimensional values (e.g., values that define a predetermined boundary) or colorable instances (e.g., objects that can have a color assigned to them), and the curve values 236 (or other values determined by the module(s) 208), where the values to be assigned to the colorable objects or instances are assigned a gradient color value selected from a gradient color value scale. The graph generator 224 may store the one or more generated graphs and/or two-dimensional images as the generated graphs 232, which are then displayable by the client device 104.

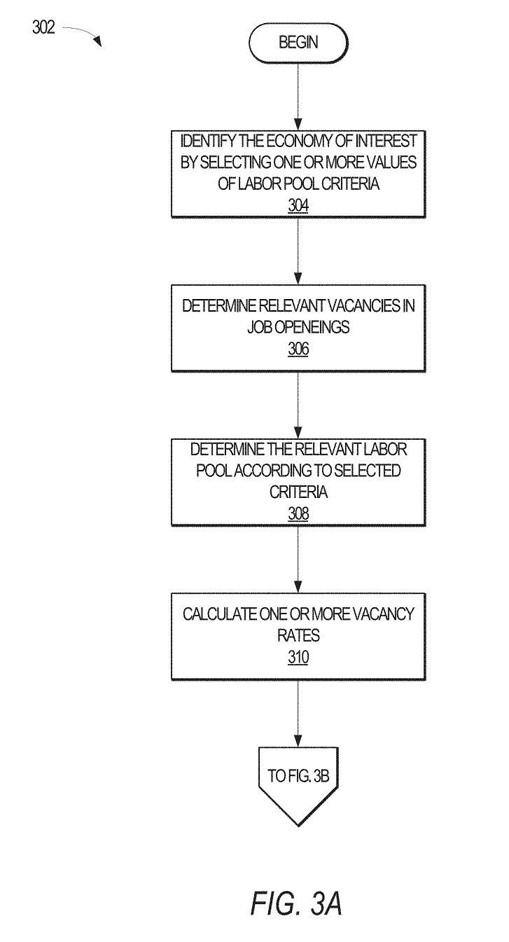

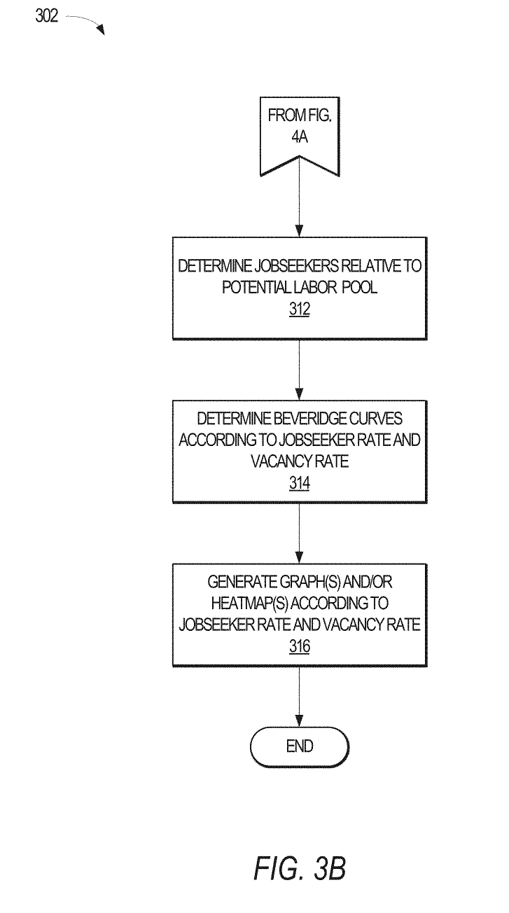

FIGS. 3A-3B illustrate a method 302, in accordance with an example embodiment, for determining frictional unemployment using the social networking information from the social networking server 112 of FIG. 1. The method 302 may be implemented by one or more of the modules 208 shown in FIG. 2, and is discussed by way of reference thereto.

Referring initially to FIG. 3A, a member, administrator, or operator of the social networking serve 112 defines the economy of interest for determining the labor market friction (Operation 304). As explained above, each of the criterion of the labor pool criteria 226 may be associated with one or more values, and the selection of these values effectively defines the economy of interest for determining the labor market friction.

The job positing identifier module 216 then identifies vacancies in one or more job postings. In one embodiment, the job posting identifier module 216 queries the job posting database 122 to obtain one or more job posting(s) 234. In querying the job posting database 122, the job posting identifier module 216 may query the job posting database 122 to return one or more job posting(s) 234 that satisfy and/or include one or more particular job posting attribute values that match (or approximately match) corresponding criterion values of the labor pool criteria 226 (Operation 308). Using the identified one or more job posting(s) 234, the social networking server 112 then determines the relevant labor pool (Operation 308). As explained above with reference to FIG. 2, the labor pool identifier module 214 identifies those member profiles that are potential matches for one or more of the job posting(s) 234. The matching between the member profile(s) 230 of the social networking service and the job posting(s) 224 may be an exact match (e.g., the member profile includes a member profile attribute value that matches one or more of the job posting qualification values), a fuzzy or approximate string match (e.g., the member profile attribute value is relevant to a job posting qualification even if the member profile attribute value does not exactly correspond to the job posting qualification value), or a combination thereof.

The social networking server 112 then determines the one or more vacancy rates 238 (Operation 310). As explained above with reference to FIG. 2, to determine the vacancy rates 238, the vacancy calculator 218 weights each of the job posting(s) 234 with the corresponding match score determined by the labor pool identifier module 214. The weight assigned to a given job posting may be the highest match score determined for the given job posting (e.g., where a job posting had multiple matches, the match with the highest match score is assigned to the job posting). The vacancy calculator 218 then computes a sum of the match scores assigned to each of the job postings to obtain a calculated vacancy value, which is stored as the vacancy rate(s) 238. The vacancy calculator 218 may be instructed and/or configured to compute one or more of these vacancy values, depending on the job posting attributes used to determine the job posting(s) 234 and/or the identified member profile(s) 230.

Having determined the vacancy value and the potential labor pool, the social networking server 112 then determines the percentage of jobseekers relative to the potential labor pool (Operation 312). Accordingly, and in one embodiment, the jobseeking calculator 220 is configured to determine the percentage of jobseekers using the potential labor pool and the relevant labor force size value. As explained previously, the percentage of jobseekers is determined based on a volatility score associated with each member profile of the potential labor pool multiplied by a weighting factor, where the weighting factor is the highest match score associated with a given member profile of the potential labor pool. In determining the percentage of jobseekers relative to the potential labor pool, the volatility score and the weighting factor are used as a numerator and the denominator is the sum of one or more weighting factors and, in particular, all the highest match scores for each member profile of the potential labor pool.

The social networking server 112 then determines one or more Beveridge curves given the determined jobseeker rate(s) and the one or more vacancy rate(s) 238 (Operation 314). In one embodiment, the curve calculator 222 determines the one or more Beveridge curves for a particular geographic region and/or industry The curve calculator 222 may determine or more curve values 236, which represent the determined one or more Beveridge curves. The curve calculator 222 may determine one or more values that correlate to selected geographic regions, selected industries, or a combination thereof. As explained above, the curve calculator 222 determines the one or more Beveridge curves using each percentage of the vacancy rates plotted against the jobseeker rates. The jobseeker rates may be used for values along an X-axis whereas the vacancy rates may be plotted along the Y-Axis.

The social networking server 112 then generates various graph(s) and/or heatmap(s) using the determined Beveridge curves, jobseeker rate(s), and/or vacancy rate(s) 238 (Operation 316). As discussed earlier, the graph generator 224 is configured to generate the one or more Beveridge curves, bar graphs, two-dimensional heatmap images (e.g., a representation of data in the form of a map or diagram in which data values are represented as colors), and other such images or combination of images. The graph generator 224 may generator the various images upon request by a member using a client device to communicate with the social networking server 112, in which case, the social networking server 112 may communicate the one or more images to the client device for display on a display communicatively coupled to the client device. Additionally, and/or alternatively, he graph generator 224 may generate the various graph(s) and/or heatmap(s) at predetermined time intervals (e.g., daily, weekly, monthly, etc.) such that the graph(s) and/or heatmap(s) are already generated when request is received (e.g., from a client device or member of the social networking service) to display the graph(s) and/or heatmap(s).

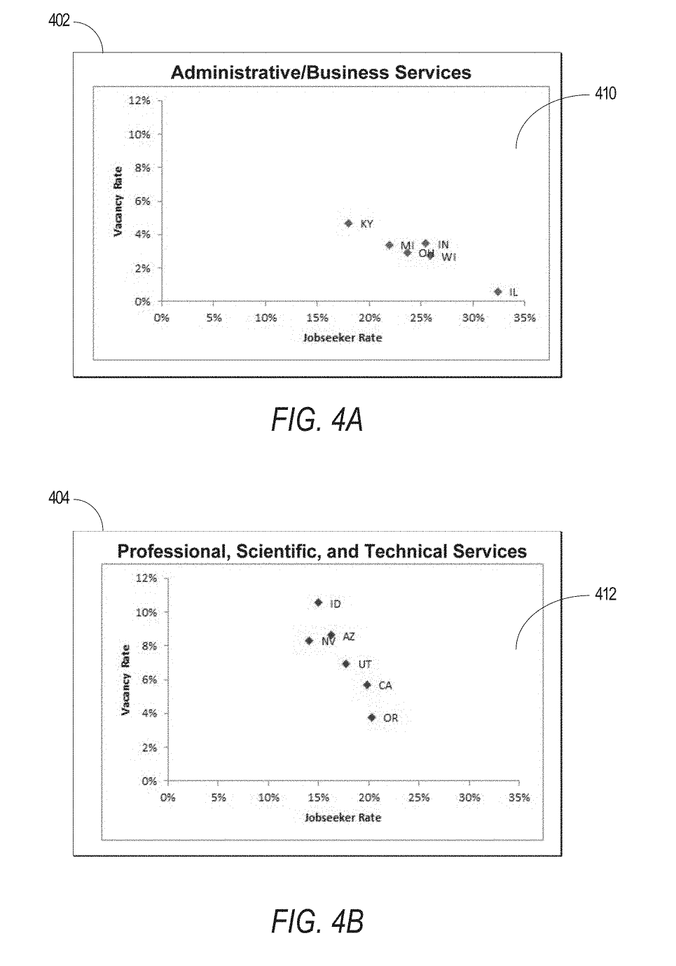

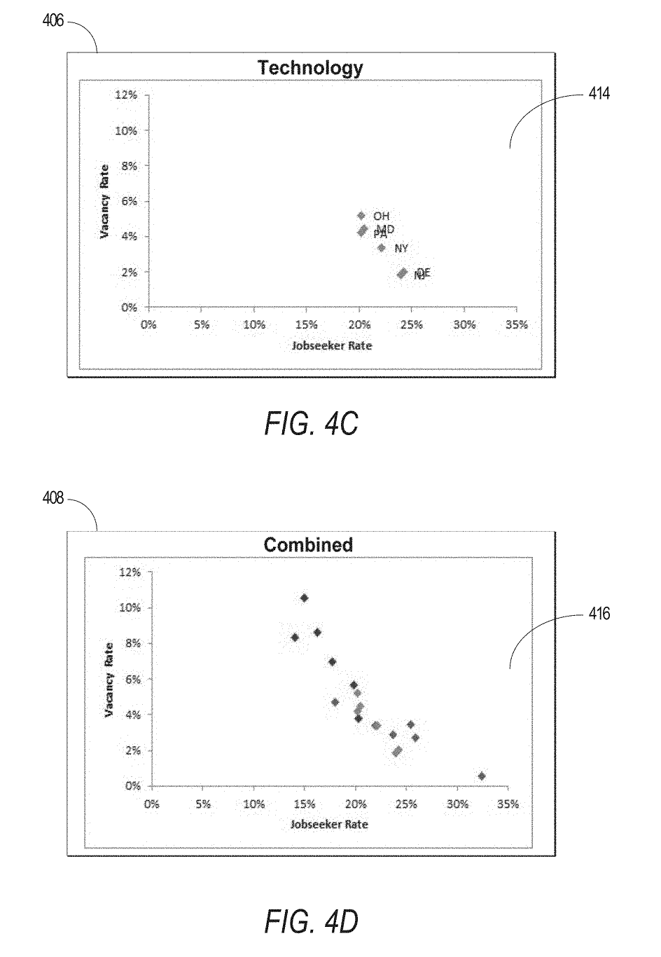

FIGS. 4A-4D illustrate images 402-408 showing corresponding Beveridge curves 410-416 for specific industries using the social networking information, according to example embodiments. FIG. 4A illustrates a first image 402 having a first Beveridge curve 410, FIG. 4B illustrates a second image 404 having a second Beveridge curve 412, FIG. 4C illustrates a third image 406 having a third Beveridge curve 414, and FIG. 4D illustrates a fourth image 408 having a fourth Beveridge curve 416. The values for each of the Beveridge curves 410-416 were determined by the curve calculator 222 where the values plotted to form the Beveridge curve 406 have been determined by the curve calculator 222.

Unlike a traditional Beveridge curve, which correlates one or more unemployment rates to vacancy rates, the Beveridge curves 410-416 illustrated in FIGS. 4A-4D correlate one or more jobseeker percentages (depicted on the X-axis) with one or more job vacancy rates (depicted on the Y-axis). By using jobseeker percentages rather than unemployment rates, the Beveridge curves 410-416 provide a clearer indication where there is a disparity between the job vacancies and the potentially employable laborers. Where there is a high job vacancy rate and a high jobseeker percentage, this disparity indicates that there is a skills gap in the geographic region, where employers are not utilizing those who are looking for employment (e.g., jobseekers). Where there is a low job vacancy rate and a high jobseeker percentage, this disparity indicates that the available jobs in the geographic region are suitably staffed, but that the employees are dissatisfied with their current employment. Where there is a high job vacancy rate and a low jobseeker percentage, this disparity indicates that the geographic region is in need of additional employees, and that the employees in the region are satisfied with their current employment. To highlight whether a particular geographic region is experiencing a skills gap (e.g., a high job vacancy rate and a high jobseeker percentage), the social networking server 112 may store one or more ratio-based thresholds (e.g., a “skills gap ratio”). In this regard, the skills gap ratio may be represented as vacancy rate/jobseeker percentage. Examples of skills gap ratio thresholds include 0.5, 0.2, 0.8, 1.0, and other such ratios.

Furthermore, each industry representable by one or more Beveridge curves may be associated with a corresponding skills gap ratio. Thus, the industry of “Administrative/Business Services” (shown in FIG. 4A) may be associated with a skills gap ratio of 0.2 whereas the industry of “Professional, Scientific, and Technical Services,” illustrated in FIG. 4B, may be associated with a skills gap ratio of 0.5. The industry and skills gap ratios may be associated as a <key, value> pair via a two-dimensional table or other logical construct, where the social networking server 112 references or queries the two-dimensional table using the industry as the key.

Each of the Beveridge curves 410-416 correspond to a specific industry and each value in the Beveridge curves 410-416 correspond to a particular geographic region. For example, the first Beveridge curve 410 corresponds to the “Administrative/Business Services” industry, and the geographic regions associated with the values of the first Beveridge curve 410 include the states of Kentucky, Michigan, Ohio, Indiana, Wisconsin, and Illinois. Similarly, the second Beveridge curve 412 corresponds to the “Professional, Scientific, and Technical Services” industry and the values in the Beveridge curve 412 correspond to the states of Indiana, Nevada, Arizona, Utah, California, and Oregon. The Beveridge curve 414 corresponds to the industry of “Technology,” and has values associated with the states of Ohio, Maryland, Pennsylvania, New York, Delaware, and New Jersey. Finally, the Beveridge curve 416 represents a combined Beveridge curve for each of the industries illustrated in FIGS. 4A-4C. Where the social networking server 112 outputs a combine Beveridge curve, such as Beveridge curve 416, the social networking server 112 may use one or more of the skills gap ratios for the industries of the combined Beveridge curve as the skills gap ratio for the combined Beveridge curve. In one embodiment, the highest skills gap ratio associated with the industries of the combined Beveridge curve is selected as the skills gap ratio. In another embodiment, the skills gap ratios are averaged to determine a skills gap ratio for the combined Beveridge curve. In this manner, the skills gap ratio for the combined Beveridge curve 416 is selected based on the skills gap ratios for each of the industries represented in the combined Beveridge curve.

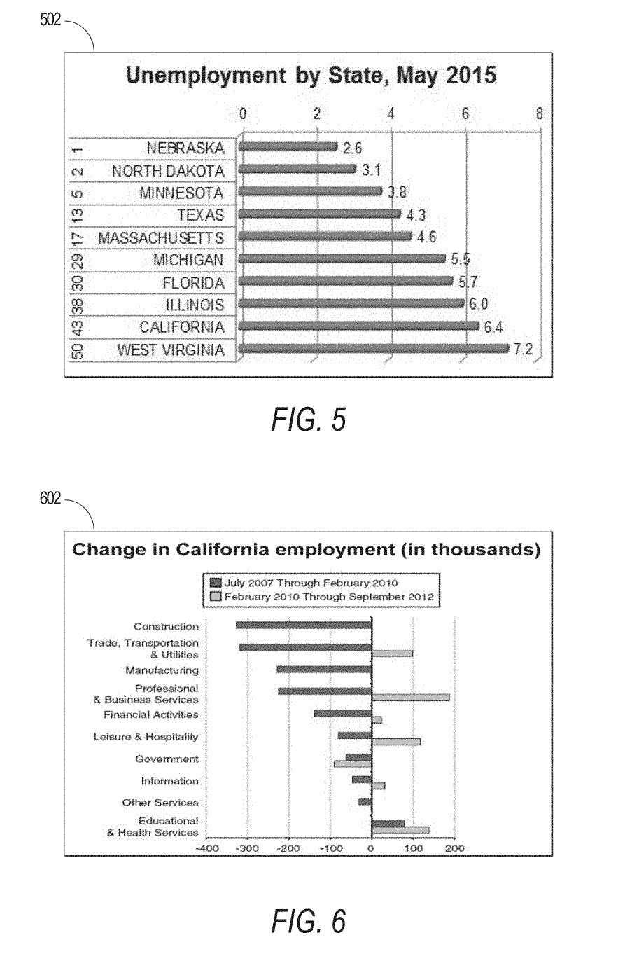

FIG. 5 illustrates a graph 502 unemployment rates determined by the social networking server of FIG. 1 using social networking information, according to an example embodiment. In one embodiment, the unemployment rate is determined using the one or more member profiles of the member profile database 120. For example, the social networking server 112 may query the member profile database 120 for member profiles where an address member profile attribute, identifying where a member associated with the member profile currently resides, is assigned a particular attribute value (e.g., “Nebraska,” “North Dakota,” etc.). Using the obtained member profiles, which may be stored as member profile(s) 230, the social networking server 112 may then count the number of member profile(s) 230 associated with a most recent employer having a closed employment date (e.g., an ending date member profile attribute for the most recent employer has a date value equal to or less than the current date). This query counts those member profile where the member was previously employed but is not currently employed. The social networking server 112 may also count those member profile(s) 230 that are not associated with an employer, which may indicate that the member is not currently employed. Using these values, the social networking server 112 obtains a ratio of the number of unemployed members to the number of total members for a selected geographic region. This ratio may then be displayed in a chart, or other image, generated by the graph generator 224. Thus, FIG. 5 illustrates the graph 502 that the graph generator 224 may generate using the unemployment ratios determined by the social networking server 112.

FIG. 6 illustrates a graph 602 of changes in employment rates for various industries determined by the social networking server of FIG. 1, according to an example embodiment. In the graph 602, the selected geographic region is “California.” Furthermore, various industries (e.g., “Construction,” “Trade, Transportation, & Utilities,” etc.) have been selected as criterion to identify particular member profiles of the member profile database 120. In addition, a date range has been established by which to identify the member profiles from the member profile database 120. In one embodiment, for each designated industry (e.g., “Construction”) of the selected geographic region (e.g., “California”), the social networking server 112 compares the number of member profiles having a most recent employer associated with the designated industry at the starting date (e.g., July 2007) with the number of member profiles having a most recent employer associated with the designated industry at the ending date (e.g., February 2010). In this manner, the social networking server 112 determines changes in employment for a designated industry in a particular geographic region using the member profiles of the member profile database 120. Furthermore, the results of the comparison, which may include one or more difference values, may be incorporated into an image (e.g., a two-dimensional bar chart) generated by the graph generator 224. The graph 602 is one example of a graph that may be generated by the graph generator 224.

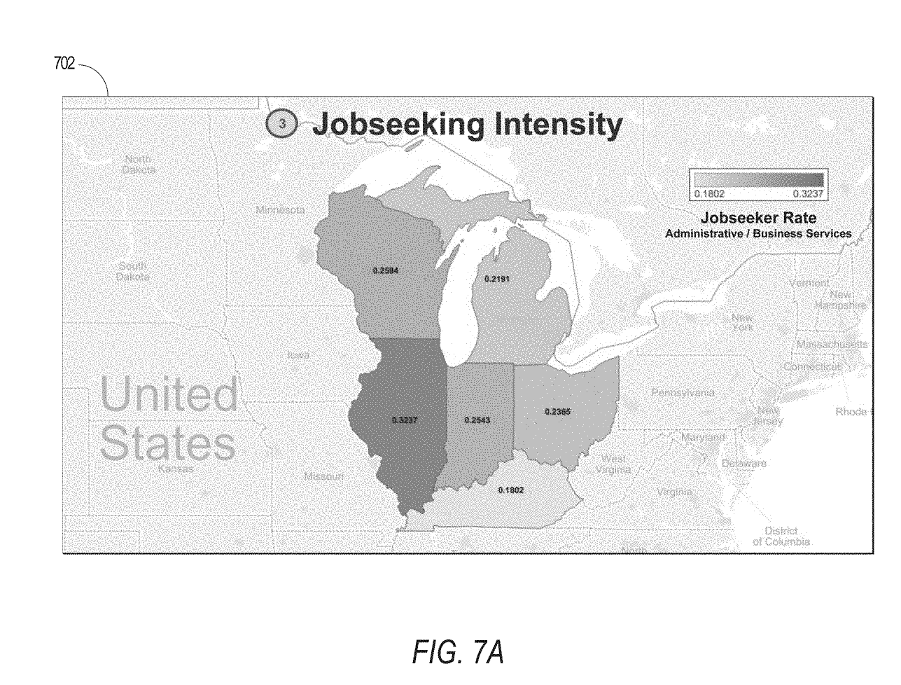

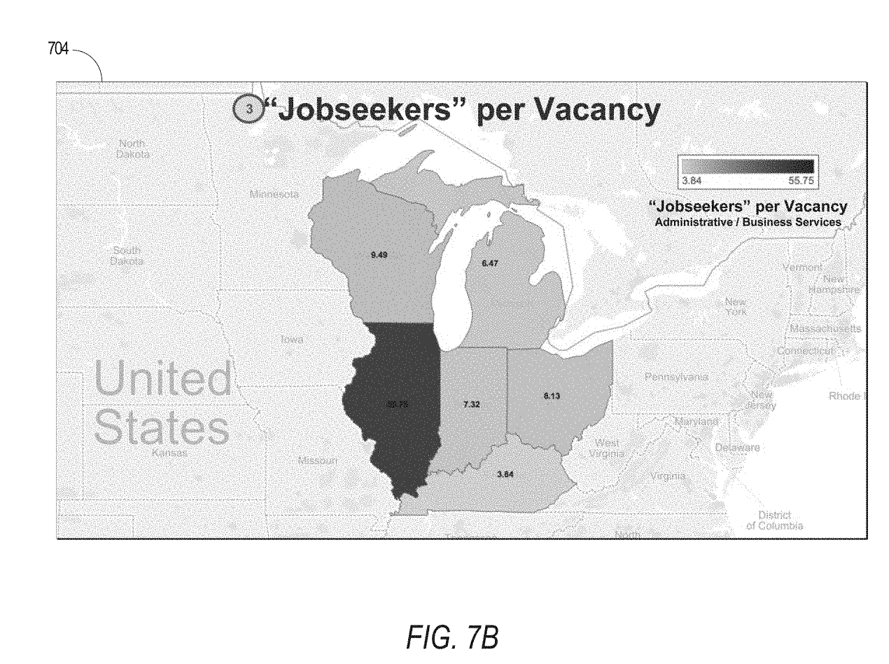

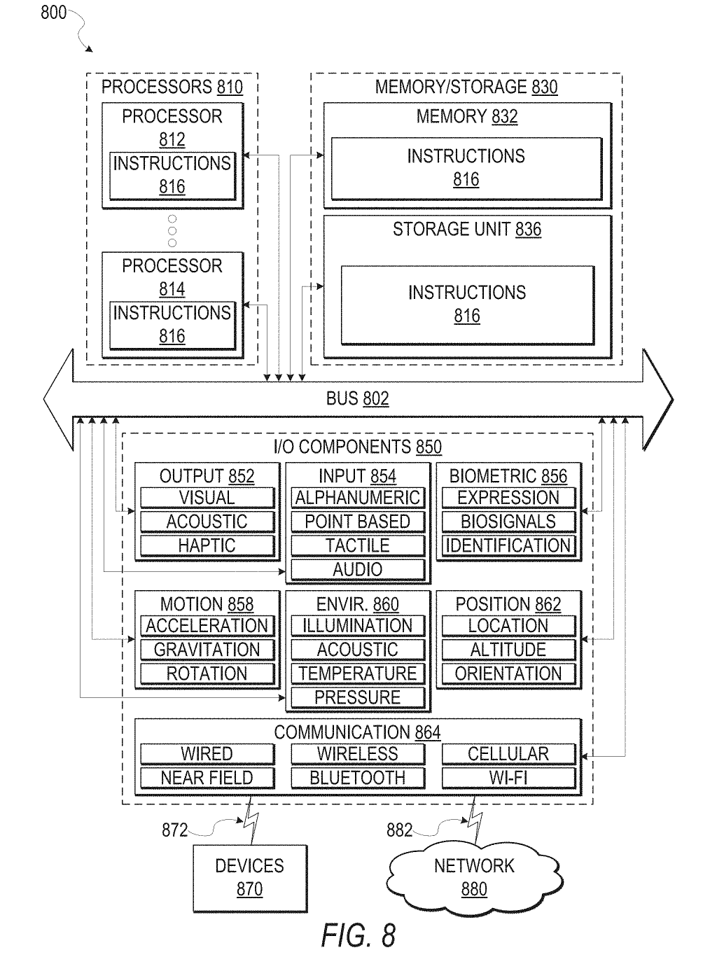

FIG. 7A-7B illustrate heatmaps 702-704 illustrating jobseeking intensity by members of a social networking service, according to example embodiments. In one embodiment, each of the heatmaps 702-704 are generated by the graph generator 224 using the jobseeking percentages and vacancy rate(s) 238 determined by the jobseeking calculator 220 and the vacancy calculator 218, respectively. Referring initially to FIG. 7A, the heatmap 702 illustrates the jobseeking rates for particular geographic regions, namely, the states of Wisconsin, Illinois, Indiana, Michigan, Ohio, and Kentucky. The graph generator 224 may compute a gradient color scale where the lowest of the jobseeking rates of the particular geographic regions is associated with the lightest shade of a gradient scale and the highest jobseeking rate of the jobseeking rates of the particular geographic regions is associated with the darkest shade of the gradient scale. Each of the remaining jobseeking rates may then be associated with a corresponding color shade determined between the lightest shade and the darkest shade. The heatmap 702 may be communicated and/or displayed to a client device in communication with the social networking server 112.

Referring to FIG. 7B, the heatmap 704 illustrates the number of jobseekers per determined vacancy for a particular geographic, according to an example embodiment. The geographic regions illustrated in FIG. 7B include Wisconsin, Illinois, Indiana, Ohio, Michigan, and Kentucky. Each of the ratios illustrated in FIG. 7B may be determined using the values determined by the jobseeking calculator 220 and vacancy calculator 218 of the social networking server 112. Similar to FIG. 7A, the lowest ratio may be assigned the lightest shade of a gradient color scale, and the highest ratio may be assigned the darkest shade of the gradient color scale. The remaining ratios may then be assigned corresponding shades of the gradient color scale in between the lightest shade and the darkest shade. Using these associations and assigned colors, the graph calculator 224 then generates the resulting heatmap, such as the heatmap 704.

Although FIGS. 4A-7B illustrate the geographic regions as states of the United States of America, the graph generator 224 may generate such graphs for more granular levels of geographic regions, such as counties and cities. A county, city, and/or state may each be member profile attributes for the member profiles accessible by the social networking server 112.

In this manner, the disclosed systems and methods provide a mechanism for illustrating labor market friction and skills gaps for particular geographic regions. Because the social networking service has access to more granular information than information available to governmental entities, the social networking server, as disclosed herein, can generate two-dimensional images (e.g., Beveridge curves, bar charts, heatmaps, etc.) that illustrate labor market friction and skills gaps at varying granularities. Using such information, policymakers, city planners, educational institutions, and other such entities can make informed decisions about the labor market for a particular geographic region and implement policies that influence the jobs and/or skills possessed by the labor force.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a FPGA or an ASIC. A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 2-7B are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Example Machine Architecture and Machine-Readable Medium

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the algorithms associated with the flow diagrams of FIGS. 3A-3B. Additionally, or alternatively, the instructions 816 may implement one or more of the components of FIG. 2. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a PDA, or any machine capable of executing the instructions 816, sequentially or otherwise, that specify actions to be taken by machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory/storage 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 812 and processor 814 that may execute the instructions 816. The term “processor” is intended to include multi-core processor that may comprise two or more independent processors (sometimes referred to as “cores”) that may execute instructions 816 contemporaneously. Although FIG. 8 shows multiple processors 810, the machine 800 may include a single processor with a single core, a single processor with multiple cores (e.g., a multi-core process), multiple processors with a single core, multiple processors with multiples cores, or any combination thereof.

The memory/storage 830 may include a memory 832, such as a main memory, or other memory storage, and a storage unit 836, both accessible to the processors 810 such as via the bus 802. The storage unit 836 and memory 832 store the instructions 816 embodying any one or more of the methodologies or functions described herein. The instructions 816 may also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of processors 810 are examples of machine-readable media.

As used herein, “machine-readable medium” means a device able to store instructions 816 and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 6. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862 among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via coupling 882 and coupling 872, respectively. For example, the communication components 864 may include a network interface component or other suitable device to interface with the network 880. In further examples, communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF416, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 880 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to devices 870. The term “transmission medium” shall be taken to include any intangible medium that is capable of storing, encoding, or carrying instructions 816 for execution by the machine 800, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a machine-readable medium storing computer-executable instructions; and
at least one hardware processor communicatively coupled to the machine-readable medium that, when the computer-executable instructions are executed, configures the system to:
receive a selection of a plurality of labor pool criterion for establishing a labor pool criteria;
determine a first plurality of job postings that satisfy the labor pool criteria, the first plurality of job postings being determined from a second plurality of job postings available from a social networking service, wherein at least one job posting of the first plurality of job postings identifies a job to be performed;
determine a first plurality of member profiles that match with one or more of the first plurality of job postings, the first plurality of member profiles being selected from a second plurality of member profiles of the social networking service;
calculate a plurality of vacancy rates for a plurality of geographic regions based on the determined first plurality of job postings, each vacancy rate corresponding to a geographic region;
calculate a plurality of jobseeker percentages for the plurality of geographic regions, each jobseeker percentage corresponding to a geographic region;
determine a plurality of ratios for the plurality of geographic regions, each ratio begin determined based on a vacancy rate and jobseeker percentage for a corresponding geographic region;
generate a first image that illustrates the plurality of ratios, wherein the first image comprises a two-dimensional graph, the graph having a horizontal axis corresponding to the plurality of jobseeker percentages and a vertical axis corresponding to the plurality of vacancy rates; and
communicate the first image for display by a client device in communication with the system.

2. The system of claim 1, wherein the plurality of labor pool criterion include at least one of an industry, an employment salary, a geographic region, and an organization type.

3. The system of claim 1, wherein a member profile selected from the first plurality of member profiles is determined by:
comparing the member profile selected from the second plurality of member profiles with each job posting of the first plurality of job postings to obtain a plurality of match scores, each match score corresponding to a comparison of the member profile with a corresponding job posting; and
determining whether any of the match scores of the plurality of match scores exceeds a predetermined match score threshold.

4. The system of claim 3, wherein the system is further configured to:
select the member profile as matching with a corresponding job posting in response to a determination that the corresponding match score exceeds the predetermined match score threshold.

5. The system of claim 1, wherein the system is further configured to:
obtain a plurality of match scores for each job posting of the first plurality of job postings by determining a match score for each member profile of the first plurality of member profiles;
compare each of the match scores with each plurality of match scores to determine a highest match score in each of the plurality of match scores; and
assign each job posting of the first plurality of job postings with the corresponding highest match score determined from the corresponding plurality of match scores associated with each job posting.

6. The system of claim 1, wherein calculating the vacancy rates for the plurality of geographic regions is further based on the highest match scores assigned to the first plurality of job postings.

7. The system of claim 1, wherein the system is further configured to generate a second image that illustrates the plurality of ratios, wherein the second image further illustrates the plurality of geographic regions with a corresponding color shade, each geographic region being associated a color shade corresponding to the ratio associated with the geographic region.

8. A method comprising:
receiving a selection of a plurality of labor pool criterion for establishing a labor pool criteria;
determining a first plurality of job postings that satisfy the labor pool criteria, the first plurality of job postings being determined from a second plurality of job postings available from a social networking service, wherein at least one job posting of the first plurality of job postings identifies a job to be performed;
determining a first plurality of member profiles that match with one or more of the first plurality of job postings, the first plurality of member profiles being selected from a second plurality of member profiles of the social networking service;
calculating a plurality of vacancy rates for a plurality of geographic regions based on the determined first plurality of job postings, each vacancy rate corresponding to a geographic region;
calculating a plurality of jobseeker percentages for the plurality of geographic regions, each jobseeker percentage corresponding to a geographic region;
determining a plurality of ratios for the plurality of geographic regions, each ratio begin determined based on a vacancy rate and jobseeker percentage for a corresponding geographic region;
generating a first image that illustrates the plurality of ratios, wherein the first image comprises a two-dimensional graph, the graph having a horizontal axis corresponding to the plurality of jobseeker percentages and a vertical axis corresponding to the plurality of vacancy rates; and
communicating the first image for display by a client device.

9. The method of claim 8, wherein the plurality of labor pool criterion include at least one of an industry, an employment salary, a geographic region, and an organization type.

10. The method of claim 8, wherein a member profile selected from the first plurality of member profiles is determined by:
comparing the member profile selected from the second plurality of member profiles with each job posting of the first plurality of job postings to obtain a plurality of match scores, each match score corresponding to a comparison of the member profile with a corresponding job posting; and
determining whether any of the match scores of the plurality of match scores exceeds a predetermined match score threshold.

11. The method of claim 10, further comprising:
selecting the member profile as matching with a corresponding job posting in response to a determination that the corresponding match score exceeds the predetermined match score threshold.

12. The method of claim 10, further comprising:
obtaining a plurality of match scores for each job posting of the first plurality of job postings by determining a match score for each member profile of the first plurality of member profiles;
comparing each of the match scores with each plurality of match scores to determine a highest match score in each of the plurality of match scores; and
assigning each job posting of the first plurality of job postings with the corresponding highest match score determined from the corresponding plurality of match scores associated with each job posting.

13. The method of claim 8, wherein calculating the vacancy rates for the plurality of geographic regions is further based on the highest match scores assigned to the first plurality of job postings.

14. The method of claim 8, further comprising generating a second image that illustrates the plurality of ratios, wherein the second image further illustrates the plurality of geographic regions with a corresponding color shade, each geographic region being associated a color shade corresponding to the ratio associated with the geographic region.

15. A non-transitory, machine-readable medium having computer-executable instructions stored thereon that, when executed by at least one hardware processor, causes a computer to perform a plurality of operations comprising:
receiving a selection of a plurality of labor pool criterion for establishing a labor pool criteria;
determining a first plurality of job postings that satisfy the labor pool criteria, the first plurality of job postings being determined from a second plurality of job postings available from a social networking service, wherein at least one job posting of the first plurality of job postings identifies a job to be performed;
determining a first plurality of member profiles that match with one or more of the first plurality of job postings, the first plurality of member profiles being selected from a second plurality of member profiles of the social networking service;
calculating a plurality of vacancy rates for a plurality of geographic regions based on the determined first plurality of job postings, each vacancy rate corresponding to a geographic region;
calculating a plurality of jobseeker percentages for the plurality of geographic regions, each jobseeker percentage corresponding to a geographic region;
determining a plurality of ratios for the plurality of geographic regions, each ratio begin determined based on a vacancy rate and jobseeker percentage for a corresponding geographic region;
generating a first image that illustrates the plurality of ratios, wherein the first image comprises a two-dimensional graph, the graph having a horizontal axis corresponding to the plurality of jobseeker percentages and a vertical axis corresponding to the plurality of vacancy rates; and
communicating the first image for display by a client device.

16. The non-transitory, machine-readable medium of claim 15, wherein the plurality of labor pool criterion include at least one of an industry, an employment salary, a geographic region, and an organization type.

17. The non-transitory, machine-readable medium of claim 15, wherein a member profile selected from the first plurality of member profiles is determined by:
comparing the member profile selected from the second plurality of member profiles with each job posting of the first plurality of job postings to obtain a plurality of match scores, each match score corresponding to a comparison of the member profile with a corresponding job posting; and
determining whether any of the match scores of the plurality of match scores exceeds a predetermined match score threshold.

18. The non-transitory, machine-readable medium of claim 15, wherein the plurality of operations further comprises:
selecting the member profile as matching with a corresponding job posting in response to a determination that the corresponding match score exceeds the predetermined match score threshold.

19. The non-transitory, machine-readable medium of claim 15, wherein the plurality of operations further comprises:
obtaining a plurality of match scores for each job posting of the first plurality of job postings by determining a match score for each member profile of the first plurality of member profiles;
comparing each of the match scores with each plurality of match scores to determine a highest match score in each of the plurality of match scores; and
assigning each job posting of the first plurality of job postings with the corresponding highest match score determined from the corresponding plurality of match scores associated with each job posting.

20. The machine-readable medium of claim 15, wherein calculating the vacancy rates for the plurality of geographic regions is further based on the highest match scores assigned to the first plurality of job postings.
